(19) United States
(12) Patent Application Publication
(10) Pub. No.: US 2003/0193283 A1
(43) Pub. Date: Oct. 16, 2003

(54) Electro-luminescent light emission device with vibration dampening

(76) Inventor: Shigehiko Aoki, Hatano-shi (JP)

Correspondence Address: Donna Angotti, Esq., SCHULTE ROTH & ZABEL LLP, 919 Third Avenue, New York, NY, 10022, US

(21) Appl. No.: 10/429,663

(22) Filed: May 2, 2003

Related U.S. Application Data
(63) Continuation of application No. 09/219,168, filed on Dec. 22, 1998, now abandoned.

(51) Int. Cl. H01J 19/12

(52) U.S. Cl. 313/269; 313/498

(57) ABSTRACT

An EL light emission device includes an expanded plastic layer provided on at least one of front and rear surfaces of an EL panel, serving as a damping layer to absorb vibration. The expanded plastic layer has air pockets existing therein, and absorbs vibration thereby substantially preventing the vibration from propagating to the circuitry of an associated electronic device (e.g., the portable telephone). This reduces the amount of noise in the electronic device, and in turn, performance is improved.

### BACKGROUND OF THE INVENTION

This invention relates to Electro-luminescent (EL) light emission devices.

Liquid crystal displays (LCDs) are utilized as display means for electronic devices, such as portable telephones and remote control units. Additionally, some electronic devices include operating panels which are illuminated thereby facilitating button operations when the electronic device is used in a dark environment. These LCDs and operating panels have backlight sources generally employing an light emitting device (LED), a fluorescent tube lamp, or the like. These backlight sources are provided with a light scattering plate for scattering the light being transmitted as a means for uniformly illuminating a display surface at the front of the LCD or the operating panel.

Recent advancements in the field of electronic devices, particularly portable telephones, have led to a reduction in their size and thickness, including the size and thickness of associated LCDs and operating panels. Consequently, there has developed a need for the backlight sources to be used in conjunction with miniaturized liquid crystal displays and operating panels which have comparable size and thickness reductions. However, devices employing an LED or flourescent tube as a backlight source require the use of both a light source and a light scattering plate, thus limiting the reduction in thickness.

For this reason, EL panels have been adopted as backlight sources for portable telephone displays and operating panels.

### SUMMARY OF INVENTION

When alternating current is applied to an EL panel, the EL panel generates vibration which causes noise to occur in the electronic device such as a portable telephone. More specifically, the vibration caused by the EL panel propagates to the circuitry of the electronic device such as the communication circuits of a portable telephone, thereby degrading the performance of the device or communication system.

It is therefore an object of the present invention to provide an EL light emission device which can be used in conjunction with an electronic device such as a portable telephone and which substantially reduces or eliminates the vibration otherwise occurring when the EL panel is energized.

The EL light emission device of the present invention includes an expanded plastic layer on at least the front or rear surface of an EL panel which serves as a dampening layer to absorb vibration. The expanded plastic layer has bubbles existing therein, which absorb vibration and prevent the vibration from propagating in the form of noise to the communication circuitry of the portable telephone or other circuitry within an electronic device, thus improving the performance of the electronic or communication system.

The expanded plastic layer may be comprised of foam adhesive tape, or it may be formed by applying and curing an expandable ink, thereby enhancing produceability. Additionally, the expanded plastic layer may be formed using a screen-printing ink with an added foaming agent. In this embodiment, the thickness of the expanded plastic layer can be controlled by adjusting the amount of the foaming agent.

### BRIEF DESCRIPTION OF DRAWINGS

FIG. 1 is a sectional view of an EL light emission device in accordance with the first embodiment of the present invention.

FIG. 2 is a sectional view of an EL light emission device in accordance with the second and third embodiments of the present invention.

FIG. 3 is a sectional view of a modification of the second and third embodiments of the present invention.

### DETAILED DESCRIPTION OF THE PREFERRED EMBODIMENT

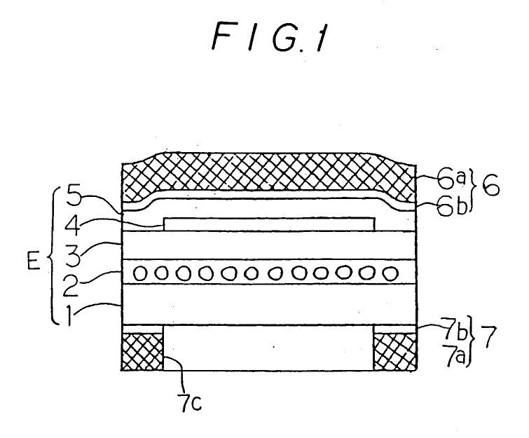

FIG. 1 depicts the pertinent parts of an EL light emission device according to the first embodiment of the present invention. As shown in FIG. 1, EL Panel E is comprised of Elements 1-5, and has, on opposite surfaces, expanded plastic layers 6 and 7.

EL Panel E includes a transparent conductive film 1 comprised of a transparent polyester film, or the like, sputtered with an indium tin oxide (ITO) thin film. The transparent conductive film 1 also has a luminous layer 2 formed on the backside thereof. Luminous layer 2 is formed by screen-print applying and curing a fluorescent material, such as zinc sulfide (ZnS), kneaded with a high dielectric binder. Insulating layer 3 is provided on the backside of luminous layer 2, and is formed by screen-printing and curing a paste of barium titanate (BATiO₃), or the like, kneaded with a high dielectric binder. Insulating layer 3 has a rear electrode 4 formed on a backside thereof which is formed only in the areas from which light emission will occur. Rear electrode 4 is constructed by printing and curing a conductive paste containing a carbon powder kneaded with a binder. Rear cover layer 5 covers rear electrode 4 and the portion of insulating layer 3 not covered by rear electrode 4. Rear cover layer 5 is formed by printing and curing a polyester-based resist.

In accordance with the present invention, an expanded plastic layer 6 is formed on the backside of the rear cover layer 5. Expanded plastic layer 6 is comprised of foam adhesive tape having layers 6a and 6b. Layer 6b is an adhesive layer used to affix the foam tape to EL Panel E, and extends over the entire backside surface of EL panel E. Layer 6a is a foamed plastic material and includes air pockets or bubbles. The foam adhesive tape may be, for example, SF033OHM manufactured by Dainippon Ink and Chemicals Inc. The foaming adhesive tape may have a rough surface due to foaming.

Another expanded plastic layer 7 is also provided on the front surface of transparent conductive film 1, and is formed of the same or similar material as foam adhesive tape 6a-6b and is therefore comprised of adhesive layer 7b and foamed plastic layer 7b. Expanded plastic layer 7 is included in areas 7c of EL Panel E which are not display areas.

Consequently, when the EL light emitting device is contact mounted within a case of an electronic device, such as a portable phone, foamed plastic layers 6a and 7a absorb vibration generated by the EL panel and prevent the vibration from propagating through the case of the electronic device to the electronic circuitry or communication circuits of the electronic device.

In production, a multitude of EL light emission bodies are formed at once in a matrix form. The matrix is cut resulting in separate EL devices. For the first embodiment of the present invention, the foam adhesive tape 6a is applied to the entire back surface of a matrix of the EL light emission bodies. Subsequently, individual light emission bodies are cut from the matrix. Thus, when individual light emission bodies are cut out, the foam adhesive tape 6a is also cut resulting in separate EL devices.

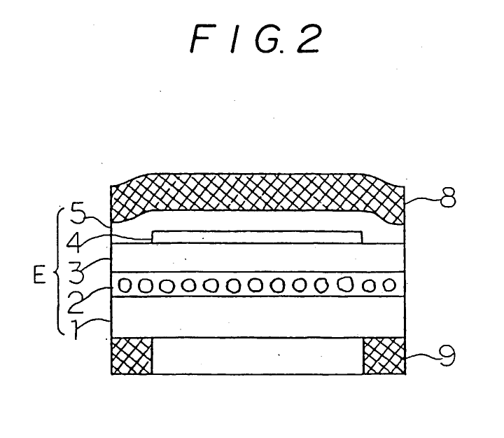

A second embodiment of the present invention is depicted in FIG. 2. As shown in FIG. 2, EL Panel E is comprised of elements 1-5 which are the same as elements 1-5 of the first embodiment shown in FIG. 1. As shown, rear cover layer 5 has an expanded plastic layer 8 on a back surface thereof, and the transparent conductive film 1 has an expanded plastic layer 9 on the front surface. The areas of EL Panel E covered by the expanded plastic layers 8 and 9 are similar to those shown in the first embodiment depicted in FIG. 1.

However, in this embodiment the expanded plastic layers 8 and 9 are formed by applying an expandable substance such as an expandable ink through a printing plate and the expandable substance is subsequently cured via a baking process. The expandable substance may be, for example, REFOAM S manufactured by Toyo Ink Manufacturing Co., Ltd. This expandable ink is printed only over the desired areas of EL Panel E using a patterned printing plate. EL panel E with printed expandable ink is subsequently baked at a temperature of approximately 110° C. thereby forming expanded plastic layers 8 and 9.

The process of forming the expanded plastic layers 8 and 9 using an expandable ink provides an advantage in that it reduces manufacturing cost since it only requires the steps of printing and baking the ink. In contrast, the process required for the first embodiment includes the more time consuming operation of affixing and cutting the adhesive foam tape. The cutting process may be troublesome when adhesive adheres to the cutting device.

In yet another embodiment of the invention similar to that depicted in FIG. 2, the expandable ink is comprised of general purpose screen-printing ink to which a foaming agent is added. The foaming agent may be, for example, an SV foaming agent manufactured, by Nagase Screen Printing Laboratory. The amount of the foaming agent utilized may be between about three (3) and about thirty (30) percent by weight to the screen-printing ink. If the added amount of the foaming agent is less than about three (3) percent by weight, the expanding phenomenon will not occur and the agent does not serve as a damping material. On the other hand, if the amount of foam agent is much greater than thirty (30) percent by weight, peeling of the resulting layer may occur. The thickness of the expanded plastic layer can be controlled by adjusting the added amount of the foaming agent. This process is therefore suited for applications in which there exists a limitation in thickness of an EL light emission device. The expandable ink with foaming agent is applied by a screen printing process over the desired areas of EL panel E and baked at a temperature of 110° C., thus forming expanded plastic layers 8 and 9.

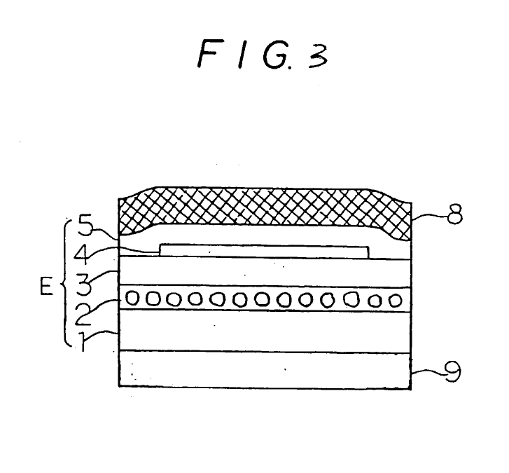

Additionally, if a transparent screen-printing ink is used, it is possible that the expandable ink will also be nearly transparent. Thus, the transparent expandable ink, may be applied over the entire front surface of the transparent conductive film 1 as shown in FIG. 3. In such a case, the expandable ink on the panel front side can also serve as a light scattering plate.

In summary, the present invention provides for an expanded plastic layer used as a vibration dampening layer to be included on at least one of the respective surfaces of an EL panel. Consequently, the vibration generated by the EL panel is absorbed and not propagated into the circuitry of the associated electronic device. Also, if the expanded plastic layer is provided by applying and baking an expandable ink, the expanded plastic layer is easy to form, thus achieving cost reduction and ease of manufacturing. Further, if the expandable ink employs a screen-printing ink added with a foaming agent by a predetermined ratio, the thickness of the expanded plastic layer can be controlled by adjusting the amount of the foaming agent.

The above-described structures of the EL light emission devices are exemplary in nature, and the sprit and scope of the present invention is to be construed broadly and limited only by the amended claims, and not the foregoing specification. It will be appreciated by those skilled in the art that the present invention is not limited to use with thick-film EL panels, but is also applicable to use with thin-film organic EL panels. Any conventional EL panel structure may be employed. Also, although the above-described embodiments included expanded plastic layers on both surfaces of the EL panel, it will be appreciated that the expanded plastic layer may be provided on only one or both of the surfaces, due to consideration such as thickness and the amount of vibration damping required.

What is claimed is:

1. An electroluminescent light emitting device for use with an electronic device comprised of:
an electroluminescent light emission panel, and
vibration dampening means affixed to at least one side of said electroluminescent light emission panel for dampening the vibration generated by said electroluminescent light emission panel and for reducing the effect of the vibration on the circuitry of said electronic device.

2. The electroluminescent light emitting device recited in claim 1, wherein said vibration dampening means comprises a layer of expanded plastic material.

3. The electroluminescent light emitting device recited in claim 2, wherein said layer of expanded plastic material is comprised of a foam adhesive tape.

4. The electroluminescent light emitting device, recited in claim 3, wherein said foam adhesive tape is affixed to, and substantially covers a rear side of said electroluminescent light emission panel.

5. The electroluminescent light emitting device recited in claim 4, wherein said foam adhesive tape is also affixed to portions of a front side of said electroluminescent light emission panel other than the portions comprising the display area.

6. The electroluminescent light emitting device recited in claim 2, wherein said layer of expanded plastic material is formed by an expandable ink.

7. The electroluminescent light emitting device recited in claim 6, wherein said expandable ink is applied to, and substantially covers a rear side of said electroluminescent light emission panel.

8. The electroluminescent light emitting device recited in claim 7, wherein said expandable ink is also applied to portions of a front side of said electroluminescent light emission panel other than the portions comprising the display area.

9. The electroluminescent light emitting device recited in claim 7, wherein said expandable ink is substantially transparent and is applied to, and substantially covers, all of a front side of said electroluminescent light emission panel.

10. The electroluminescent light emitting device recited in claim 2, wherein said layer of expanded plastic material is formed by a screen printing ink with a foaming agent.

11. The electroluminescent light emitting device recited in claim 10, wherein said screen printing ink and foaming agent is applied to, and substantially covers, a rear side of said electroluminescent light emission panel.

12. The electroluminescent light emitting device recited in claim 10, wherein said screen printing ink and foaming agent is also applied to portions of a front side of said electroluminescent light emission panel other than proportions comprising the display area.

13. The electroluminescent light emitting device recited in claim 10, wherein said screen printing ink and foaming agent is substantially transparent and is applied to, and substantially covers, all of a front side of said electroluminescent light emission panel.

14. The electroluminescent light emitting device recited in claim 10, wherein the thickness of said expanded plastic layer can be controlled by varying the amount of said foaming agent added to said screen printing ink.

15. The electroluminescent light emitting device recited in claim 1, wherein said vibration dampening means is comprised of a screen printing ink combined with a foaming agent, and the thickness of said vibration dampening means is controlled by varying the amount of said foaming agent added to said screen printing ink.

16. A method of making a plurality of electroluminescent light emitting devices each comprised of an electroluminescent light emission panel and a vibration dampening layer comprising the steps of:
making a matrix of electroluminescent bodies;
affixing a layer of vibration dampening substance to substantially an entire surface of said matrix of electroluminescent bodies; and
separating the electroluminescent bodies in the matrix to form individual electroluminescent devices comprising an electroluminescent light emission panel with a vibration dampening layer.

17. The method recited in claim 16, wherein said vibration dampening material is an expandable plastic material.

18. The method recited in claim 17, wherein the expandable plastic material is comprised of an adhesive foam tape.

19. The method recited in claim 17, wherein the expandable plastic material is comprised of an expandable ink.

20. The method recited in claim 17, wherein the expandable plastic material is comprised of a screen printing ink combined with a foaming agent.

21. The method recited in claim 19, wherein said step of affixing a vibration dampening layer comprises the steps of applying a coating of expandable ink and curing said expandable ink at temperatures of approximately 110° C.

22. The method recited in claim 19, further comprising the step of affixing a vibration dampening material layer to substantially all of a surface of a second side of the electroluminescent bodies except portions of said bodies comprising display areas.

23. The method recited in claim 19, wherein said expandable ink is substantially transparent and is applied to substantially all of the surface area of both sides of said matrix of electroluminescent bodies.

24. The method recited in claim 20, wherein said step of affixing a vibration dampening material layer comprises the steps of:
adding a desired amount of a foaming agent to a screen printing ink;
applying a coating of said screen printing ink with foaming agent; and
curing said screen printing ink with foaming agent at temperatures of approximately 110° C.

25. The method recited in claim 20, wherein said screen printing ink with foaming agent is applied to substantially all of the surface of both sides of said matrix of electroluminescent light emission bodies except portions comprising display areas.

26. The method recited in claim 20, wherein said screen printing ink with foaming agent is substantially transparent and is applied to substantially both sides of said matrix of electroluminescent light emission bodies.

27. The method recited in claim 20 further comprising the step of:
determining the desired thickness of said layer of vibration dampening material, and varying the amount of said foaming agent added to said screen printing ink according to the desired thickness.

28. A method of generating an electroluminescent light emitting device for use with an electronic device comprising the steps of:
forming an electroluminescent light emission panel; and
affixing a vibration dampening material layer to at least one side of said electroluminescent light emission panel so that said vibration dampening layer reduces the effect of vibration generated by said electroluminescent light emission panel on the circuitry of said electronic device.
